(19) United States
(12) Patent Application Publication
(10) Pub. No.: US 2013/0097501 A1
(43) Pub. Date: Apr. 18, 2013

(54) Information Search and Method and System

(71) Applicant: Yong Zhen Jiang, Beijing (CN)

(72) Inventor: Yong Zhen Jiang, Beijing (CN)

(21) Appl. No.: 13/436,962

(22) Filed: Apr. 1, 2012

Related U.S. Application Data
(60) Provisional application No. 61/472,196, filed on Apr. 6, 2011.

(51) Int. Cl. G06F 3/0482

(52) U.S. Cl. CPC G06F 3/0482
USPC 715/716

(57) ABSTRACT

The present invention relates to methods and systems for interacting with and querying information using user interfaces of mobile or hand-held devices with, preferably, touch-sensitive displays. The method comprises receiving electronic media content from a plurality of media sources and displaying the electronic media content in accordance with pre-determined criteria, providing a process for selecting one or more portions of the displayed electronic media content, wherein the process includes defining boundaries and position of a selection area, such that the displayed electronic media content overlapping the selection area is included in selected content; and wherein information associated with the selected content is operable for creating a request for information.

### RELATED APPLICATIONS

The present application claims priority of the U.S. Provisional Patent Application Ser. No. 61/472,196, filed Apr. 6, 2011, entitled Information Search Method and System, which is incorporated herein by reference.

### FIELD OF THE INVENTION

The present invention relates generally to the areas of computer software and electronics, including mobile devices, more specifically to the areas of information searching involving a computer network. One aspect of the present invention relates to methods and systems for interacting with user interfaces of mobile or hand-held devices with touch-sensitive displays. Another aspect of the invention relates to methods and systems for efficiently querying information using a mobile or a hand-held device. Another aspect of the present invention relates to presenting information associated with an information query performed on a mobile or hand-held devices with one or more touch-sensitive displays.

### BRIEF DESCRIPTION OF THE DRAWINGS

Various embodiments are disclosed in the following detailed description and the accompanying drawings.

FIG. 1 is an exemplary block diagram of a distributed computing system 100.

FIG. 2 is a flow diagram illustrating a method 200 performed at a client device according to some embodiments of the present invention.

FIG. 3 is a block diagram illustrating a client 102 in accordance with one embodiment of the present invention.

FIGS. 4A-4C illustrate exemplary user interfaces (400A-400C) in accordance with some embodiments of the present invention.

FIG. 5 illustrates an exemplary user interface for selecting one or more portion of displayed electronic content in accordance with some embodiments of the present invention.

FIG. 6 illustrates an exemplary user interfaces for selecting one or more portions of displayed electronic content in accordance with some embodiments of the present invention.

FIGS. 7 and 8 illustrate exemplary user interfaces in accordance with some embodiments of the present invention.

### DETAILED DESCRIPTION

The invention can be implemented in a number of ways, including as a process, apparatus, a system, user interfaces, a computer readable medium such as a computer readable storage medium or a computer network wherein program instructions are sent over electronic communication links and nodes. In general, the order of the steps of the disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. Specific details are set forth in the following description in order to provide a thorough understanding of the invention. These details are provided for exemplary purposes though the invention may be practiced according to the claims without some or all of the specific details disclosed. For purposes of clarity, technical materials known in the technical fields relating to the invention has not been described in detail so that the invention is not unnecessarily obscured.

### DEFINITIONS

“User interaction” refers to any communication between a user and a an electronic device involving a movement and/or gesture performed by a user of a device. Such movements and/or gestures may differ depending on the device being used. For example, for computing devices with a touchscreen or touchpad, a user may interface with such devices using one or more of the user's fingers to perform gestures (e.g., taps, swipes, drags, movement of cursor) recognizable by the device. For computing devices with inputs for conventional mouse and keyboard interfaces, the user may also use conventional mouse and keyboard input methods to communicate with the device. For devices with interfaces capable of biometric input, user interaction would include communicating through such interfaces, biometric information of the user, such as the user's voice, eye movement and position, hand gestures (regardless of whether physical contact is made with the device itself), facial expressions, and other biometric factors indicative generally of the user's state of mind, physical state, attention span and focus.

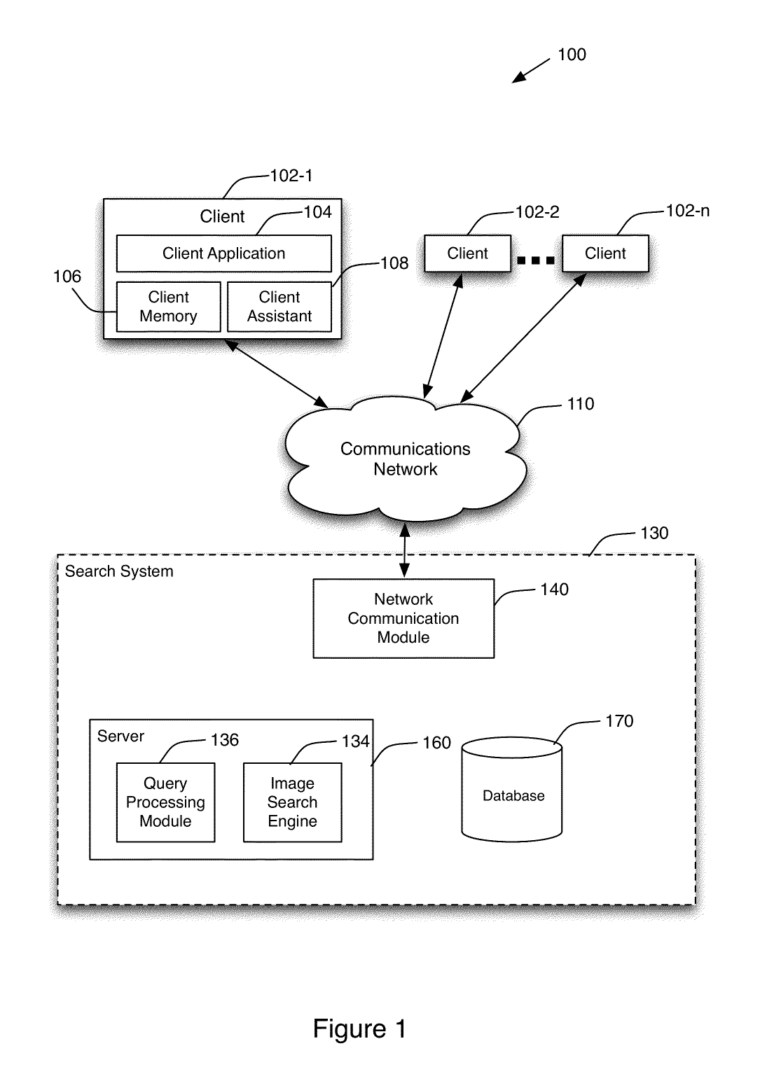

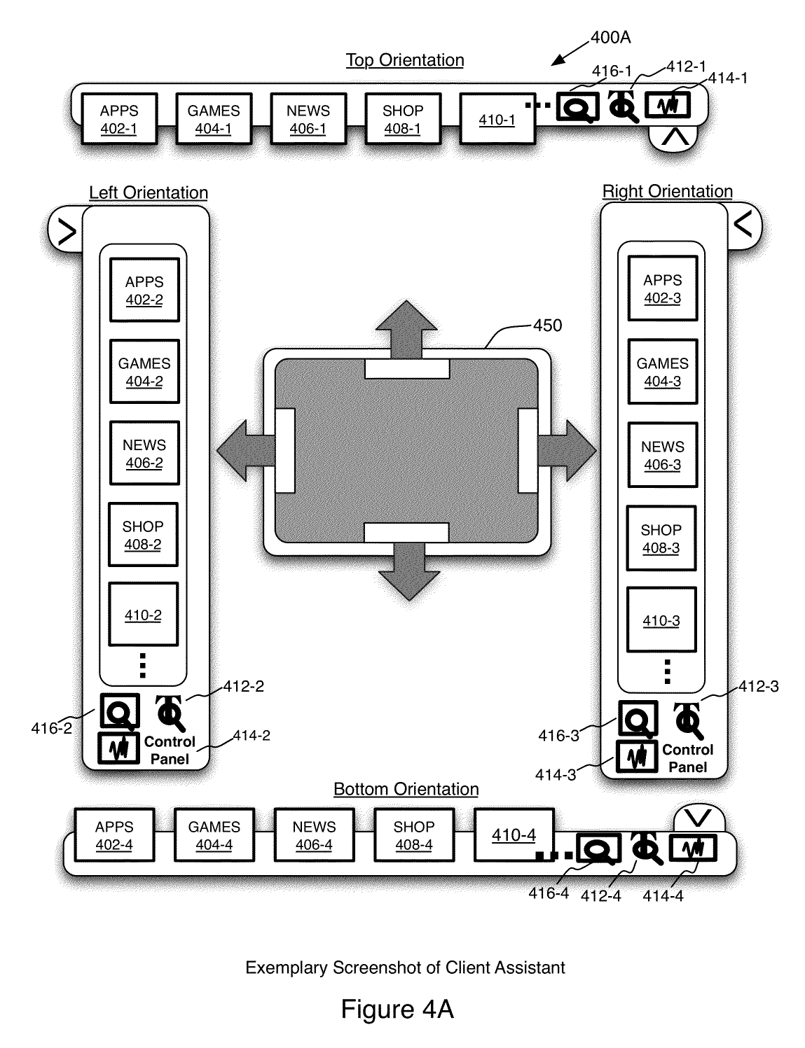

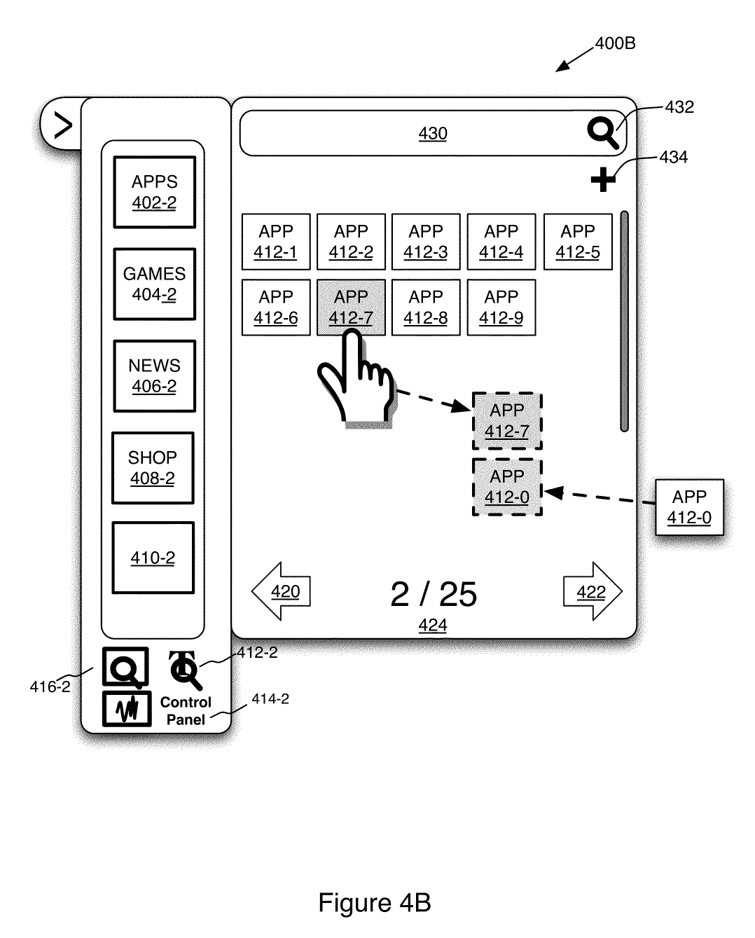

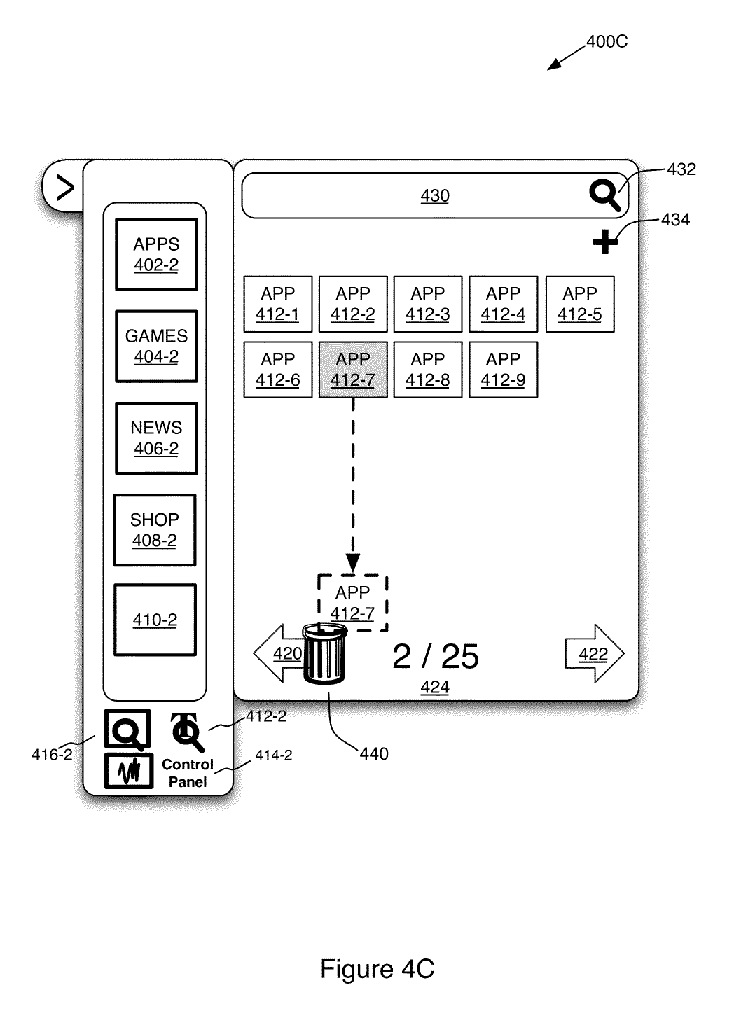

FIG. 1 is an exemplary block diagram of a distributed computing system 100. FIG. 1 includes a search system connected to a plurality of clients 102 (e.g., 102-1 . . . 102-n) through a network 110 such as the Internet, other wide area networks, local area networks, metropolitan area networks, wireless networks, or any combination of such networks. In some embodiments, a respective client 102 contains one or more client applications 104, such as a web browser, capable of submitting search requests to the information search system 130. The client 102 (sometimes called the “client device” or “client computer”) may be any computer or similar device through which a user of the client 102 can send requests to and receive results or information services from the information search system 130. Examples include, without limitation, desktop computers, notebook computers, tablet computers, internet kiosks, mobile devices such as mobile phones, personal digital assistants, gaming devices, set-top boxes, or any combination of the above. In some embodiments, the client device 102 includes a client assistant 108, which in some embodiments is a graphical user interface (GUI), further described in greater detail herein with reference to FIGS. 4A-4D. In some embodiments, the client assistant 108 is a stand-alone application on the client device 102. In some embodiments, the client assistant 108 is a component within client application 104 (e.g., plug-in). One embodiment of client 102 is described in greater detail herein with reference to Figure x.

Search system 130 includes on or more servers, such as server 160, connected to the communications network 110 via network communication module 140. Search system 130 may also include datastore 170 and image search engine 134.

Server 160 includes query processing module 136 and image search engine 134.

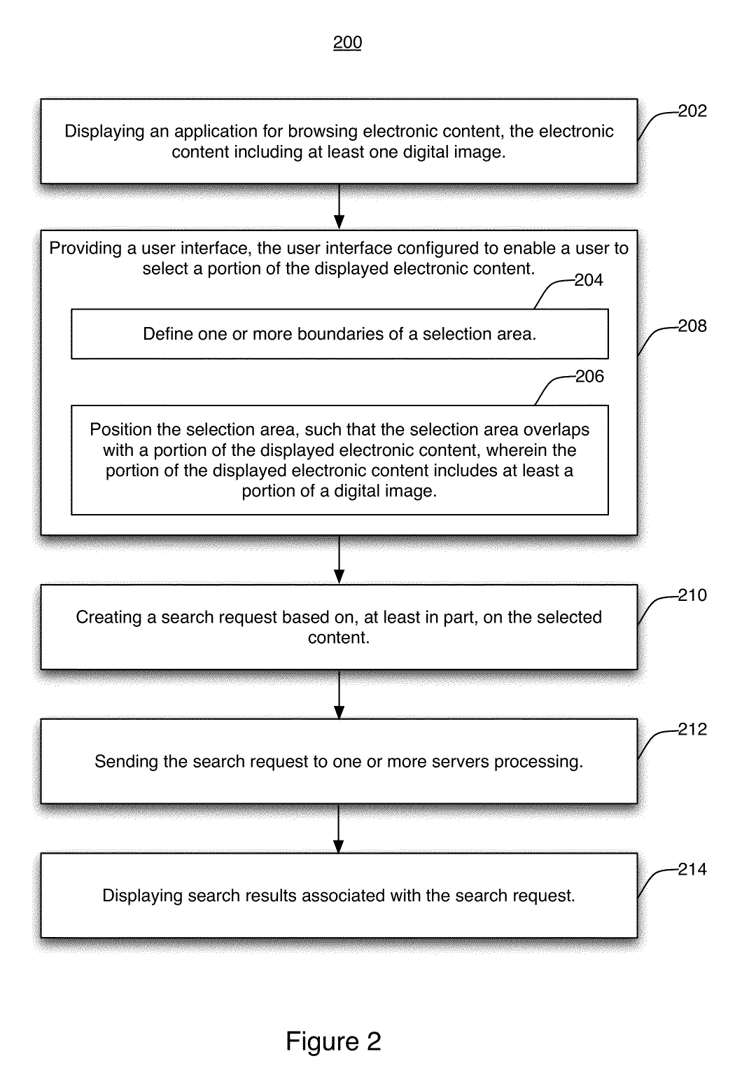

FIG. 2 is a flow diagram illustrating a method 200 performed at a client device according to some embodiments of the present invention. The client device displays (202) an application for browsing electronic content. In some embodiments, the electronic content is received from a plurality of media sources. The media sources may include, for example, blogs, social networking sites, retailer and shopping websites, news media, syndicated feeds, and other information sources accessible via a network (e.g., internet or intranet). In some embodiments, the electronic content is created from a combination of information from the internet, locally available information on the device, information transmitted from a third party (e.g., a contact, a service provider).

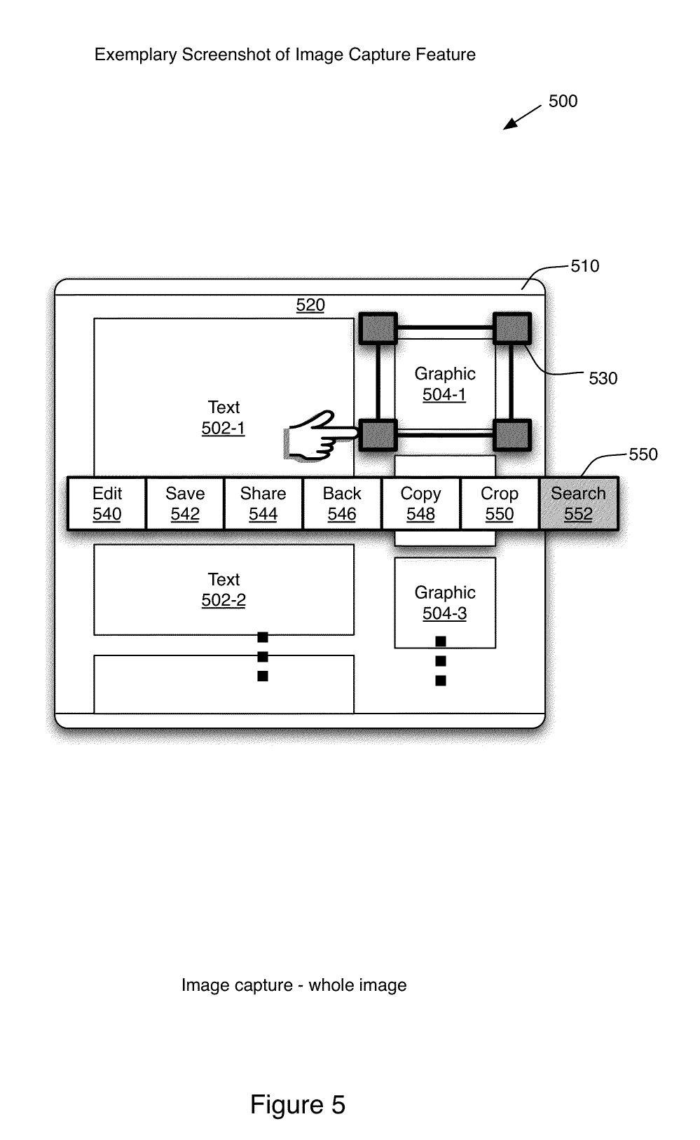

The client device provides (208) a user interface, wherein the user interface is configured to enable a user to select a portion of the displayed electronic content. Selecting a portion of the displayed electronic content includes defining (204) one or more boundaries of a selection area, and positioning (206) the selection area, such that the displayed electronic content overlapping the selection area is included in selected content. Discussion below in reference to FIGS. 5 through 8 provide more information on how the displayed electronic content can be selected. The selected content may be associated with a superset or subset of: a digital image, a portion of a digital image, video, audio, or at least one keyword which may be provided by the current user. Additionally, the keyword(s) included in the selected content may also be derived from prior analysis performed on the other information similar to the information contained in the selected content.

The client device may create (210) a search request based on, at least in part, on the selected content. If a search request is created, the search request is sent (212) to one or more servers for processing. Other information, in addition to that in the selected content, may be included in the search request. For example, metadata associated with a location of a user of the client device, a location of the client device, and also other viewers of the electronic media content could also be included as a part of the search request. Inclusion of additional metadata would improve and enhance search results returned to the client device.

Search results associated with the search request are displayed (214). The search results may be displayed as a listing of relevant results. In some embodiments, search results are in the form of multimedia files, including video and audio which may be automatically played back to the user. The results can also include information closely associated with subject of the search request. For example, if the search request was in regards to a shopping item, the results could include other items similar to the shopping item. The results could further include information from a third party related to the shopping item, e.g., local events, such as sales involving or related to the searched item, opinions from contacts associated with the user, and the like.

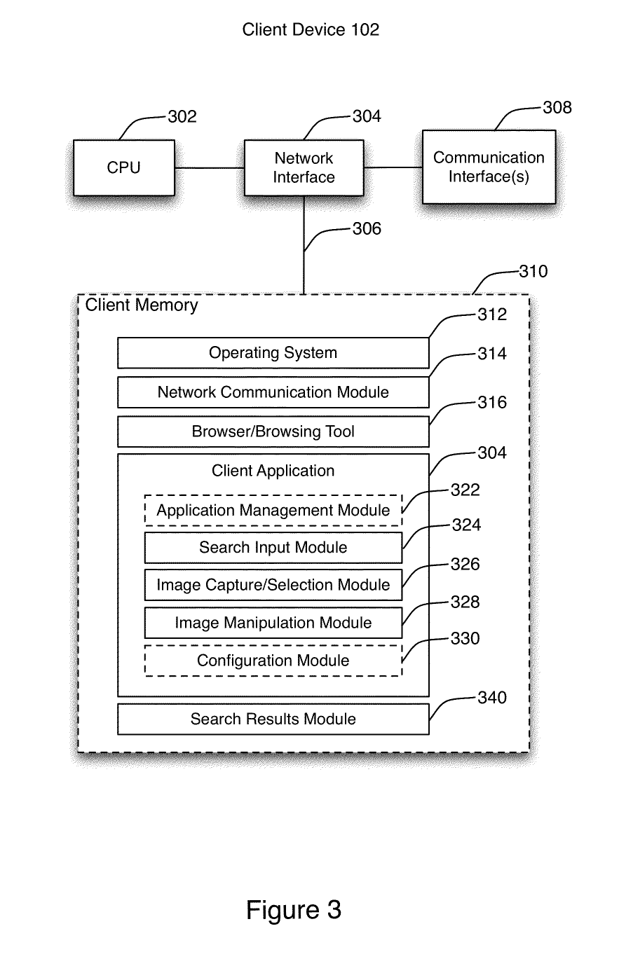

FIG. 3 is a block diagram illustrating a client 102 in accordance with one embodiment of the present invention. The client 102 typically includes one or more processing units (CPU's) 302, one or more network or other communications interfaces 308, memory 310, and one or more communication buses 306 for interconnecting these components. The communication buses 906 may include circuitry (sometimes called a chipset) that interconnects and controls communications between system components. The client 102 optionally may include a user interface comprising a display device (e.g., multi-touch input display) and a keyboard and/or mouse, sound input device (e.g., microphone). Memory 310 includes high-speed random access memory, such as DRAM; SRAM, DDR RAM or other random access solid state memory devices; and may include non-volatile memory, such as one or more magnetic disk storage devices, optical disk storage devices, flash memory devices, or other non-volatile solid state storage devices. Memory 310 may optionally include one or more storage devices remotely located from the CPU(s) 302. Memory 310, or alternately the non-volatile memory device(s) within Memory 310, comprises a computer readable storage medium. In some embodiments, Memory 310 stores the following programs, modules and data structures, or a subset thereof:
An operating system 312 that includes procedures for handling various basic system services and for performing hardware dependent tasks;
A network communication module 314 that is used for connecting the client device 102 to other computers via the one or more communication network interfaces (wired or wireless) and one or more communication networks, such as the Internet, other wide area networks, local area networks, private networks, metropolitan area networks, and so on; and
a client application 104 such as a browser for displaying documents such as web pages, and for sending queries to an receiving query responses to an online service, such as a search engine or other information service; in some embodiments, client application 104 include word processors, document reading software and/or applications; and
a browser/browsing tool 316;
a search results module 340 for displaying and presenting to a user search results returned by the search system 130.

The procedures in the client application module 104 may include an application management module 322 that includes procedures for managing and organizing applications; a search input module 324 that includes procedures for searching through programs, applications, and other information; an image capture/selection module 326 that includes procedures for capturing and selecting images and other electronic content; an image manipulation module 928 that includes procedures for manipulating images stored either locally or remote from the client device; and a configuration module 330 that includes procedures for configuring the client application 140 or other applications stored either locally or remote from the client device.

Each of the above-identified elements may be stored in one or more of the previously mentioned memory devices, and corresponds to a set of instructions for performing a function described above. The above-identified modules or programs (i.e., sets of instructions) need not be implemented as separate software programs, procedures or modules, and thus various subsets of these modules may be combined or otherwise rearranged in various embodiments. In some embodiments, memory 310 may store additional modules, data structures, and other components not described above.

FIGS. 4A-4C illustrate exemplary user interfaces (400A-400C) in accordance with some embodiments of the present invention.

In FIG. 4A, a number of exemplary orientations including top, bottom, left, and right are shown, as well as, exemplary category icons, as further described below. The orientation of the user interface changes depending on instructions received from the user (e.g., finger movement dragging the user interface to a new location, setting of menu location in a preferences/options menu). In some embodiments, user interface 400A includes the following elements, or a subset or superset thereof:
Application (“APPS”) module 402 (e.g., 402-1, 402-2, 402-3, 402-4) for organizing and managing applications located either locally on the client device 102 or remotely (e.g., a network server) from the client device 102;
Games (“Games”) module 404 (e.g., 404-1, 404-2, 404-3, 404-4) for organizing and managing games located either locally on the client device 102 or remotely from the client device 102;
News (“News”) module 406 (e.g., 406-1, 406-2, 406-3, 406-4) for viewing information compiled from one or more information sources (e.g., user's favorite website, RSS feeds, sources associated with other users within the user's network (“social” network), sources recommended by an administrator of a network that the user belongs to);
Shop (“Shop”) module 408 (e.g., 408-1, 408-2, 408-3, 408-4) for viewing e-commerce information from one or more information sources (e.g., user's past and current shopping preferences, shopping activities and preferences associated with other users with the user's network, shopping activities associated with an administrator of a network that the user belongs to);
Text Search module 412 (e.g., 412-1, 412-2, 412-3, 412-4) for constructing and submitting search requests involving electronic content containing text, keywords, and textual characters;
Control Panel module 414 (e.g., 414-1, 414-2, 414-3, 414-4) for managing and manipulating preferences and options associated with the client device, the client application, and/or the content displayed; and
Image Search module 416 (e.g., 416-1, 416-2, 416-3, 416-4) for constructing and submitting search requests involving electronic content containing one or more images or a portion thereof.

In some embodiments, user interface 400B includes the following elements, or a subset or superset thereof:
402, 404, 406, 408, 410, 412, 414, 416, as described above;
Icons 412 (e.g., 412-1 . . . 412-9) for applications manageable within the interface;
Search box 430 and search button 432, which provides text searching of the client device and/or information stored remote from the client device;
Add new applications module 434, which provides for the browsing of, and then the adding of new icons for additional applications that the user wishes to manage within the user interlace; and
Forward 420 and backward 422 buttons for scrolling through the displayed content, if necessary.

In some embodiments, a user can configure the icons displayed through one or more user interactions with the user interface. For example, if the client device 102 includes a touch-sensitive display, the user can add new icons into the user interface by dragging and dropping icons (e.g., through one or more finger gestures) from locations external to the user interface. In another example, the user can add new icons into the user interface by using methods involving the search box 430 and search button 432 described above. In some embodiments, the user can manually input keywords into the search box 430. In some embodiments, the client device displays pre-populated search results matching the user's inputted keywords. In some embodiments, the user can add new icons by selecting 434, which for example, may provide a listing of applications from which the user can select from. In some embodiments, the listing of applications includes applications located on the client device, applications located remotely from the client device (e.g., on a cloud server), and/or any combination of the above.

In some embodiments, user interface 400C includes the following elements, or a subset or superset thereof:
402, 404, 406, 408, 410, 412, 414, 416, 418, 420, 422, 432, and 434 as described above; and
area for deleting (e.g., trashcan) icons 440;

In some embodiments, a user deletes icons by moving the icon (e.g., 412-7) a predefined area on the user interface (e.g., 440). In some embodiments, the predefined “deletion” area is hidden under normal operating circumstances. In some embodiments, the “deletion” area 440 is displayed under normal operating circumstances. In some embodiments, the “deletion” area 440 is displayed when the client device 102 detects certain user actions (e.g., drag-drop motion dragging an icon into the vicinity of the delection area). In some embodiments, a user can modify settings, preferences, options and other parameters associated with the user interface to change the behavior of the deletion area.

FIG. 5 illustrates an exemplary user interface for selecting a portion of displayed electronic content in accordance with some embodiments of the present invention. In some embodiments, user interface 500 includes the following elements, or a subset or superset thereof:
an application 510 (e.g., a web browser) for displaying a variety of electronic content, such as text 502-1, 502-2, and a plurality of images 504-1, 504-2 (not shown), and 504-3;
a user-moveable selection area 530 for selecting portions of the displayed electronic content 520; and
menu options 550, including one or more of the following: an edit icon/button 540 for editing content; a save icon/button 542 for saving and/or storing content into memory; a cancel icon/button 544; a back icon/button 546; a copy icon/button 548; a crop icon/button 550; and a search icon/button 552.

In some embodiments, the application 510 is configurable to display a variety of electronic content including text, images, hyperlinks, or a combination of the above. In some embodiments, the application 510 is a document processing application (e.g., Microsoft Word, WordPerfect, Pages). In some embodiments, the application 510 is a web or internet browser (e.g., Microsoft Internet Explorer, Mozilla Firefox, Opera).

In some embodiments, the user-moveable selection area 530 is operable for defining one or more portions of the displayed electronic content 520 as a selected area for further processing. In some embodiments, portions within the boundaries of the selection area 530 (e.g., graphic 504-1) are selected. In some embodiments, the selection area 530 is operable for selecting one or more portions of the displayed content 520, such that portions “outside” or beyond the boundaries of the selection area 530 comprise the selected portions. The boundaries of the selection area 530 may be defined by a number of geometric shapes, including, for example, one or more squares, rectangles, triangles, circles, and ellipses. The boundaries are also adjustable by user interaction with elements associated with the selection area 530 (e.g., one or more corners of the selection area, one or more boundaries of the selection area, area surrounded by the boundaries of the selection area).

In some embodiments, the boundaries of the selection area is based on an prior analysis already performed on the image. An image may already include several pre-tagged elements that are user-selectable without the user having to define the boundaries of the selection area. For example, an image of a model with wearing a red hat paired with red shoes may have user-selectable “tags” associated with the hat and the shoes on the image itself. In this instance, the user can simply select the “tag” and search based on information that is associated with the “tag” and the image.

In some embodiments, the selection area 530 is displayed upon user interaction with a displayed graphic.

In some embodiments, after defining the selected portion(s) through the process described above, the user interface 500 is configurable to allow further processing to be performed on the content included within the selected portion(s). For example, as further described above in reference to user interface 500, options for further processing of the selected portion(s) include edit (e.g., 540), save (e.g., 542), cancel (e.g., 544), back (e.g., 546), copy (e.g., 548), crop (e.g., 550), and search (e.g., 552).

In some embodiments, the edit feature/option allow a user to edit the selected portion(s). In some embodiments, activating the edit feature/option initiates editing of the selected portion(s) in an image editing application.

In some embodiments, the save feature/option allow a user to store the selected portion(s) in memory available either locally on the client device 102 or physically remote from the client device 102. The selected portion(s) may be stored in volatile memory (e.g., clipboard) or in non-volatile memory (e.g., device harddrive, flash memory).

In some embodiments, the search feature/option allows a user to submit a search query with the selected content. In some embodiments, activating the search feature (e.g., search icon 552) automatically submits the selected content to a search engine and/or information search service. In some embodiments, one or more windows of a browsing application (e.g., web browser) is displayed with one or more of the following: the selected content, search results associated with the search content, including images, texts, and other media matching the search query. In some embodiments, the search results returned include results associated with the user's past search activities (e.g., search history, shopping history, viewing history), predefined user preferences, search results associated with the user's electronic social network (e.g., instant messaging friends, contacts and connections in a social networking application), search results associated with an organization in which the user belongs to (e.g., company media administrator). In some embodiments, the options/features include a share option, where electronic content can be sent to one or more servers remote from the client device, and/or other network infrastructure associated with a relationships network. Photo album feature: can share pictures with social network; combination of pictures from various social networks, downloadable to client; can do image matching search (key feature). Image capture: screenshot.

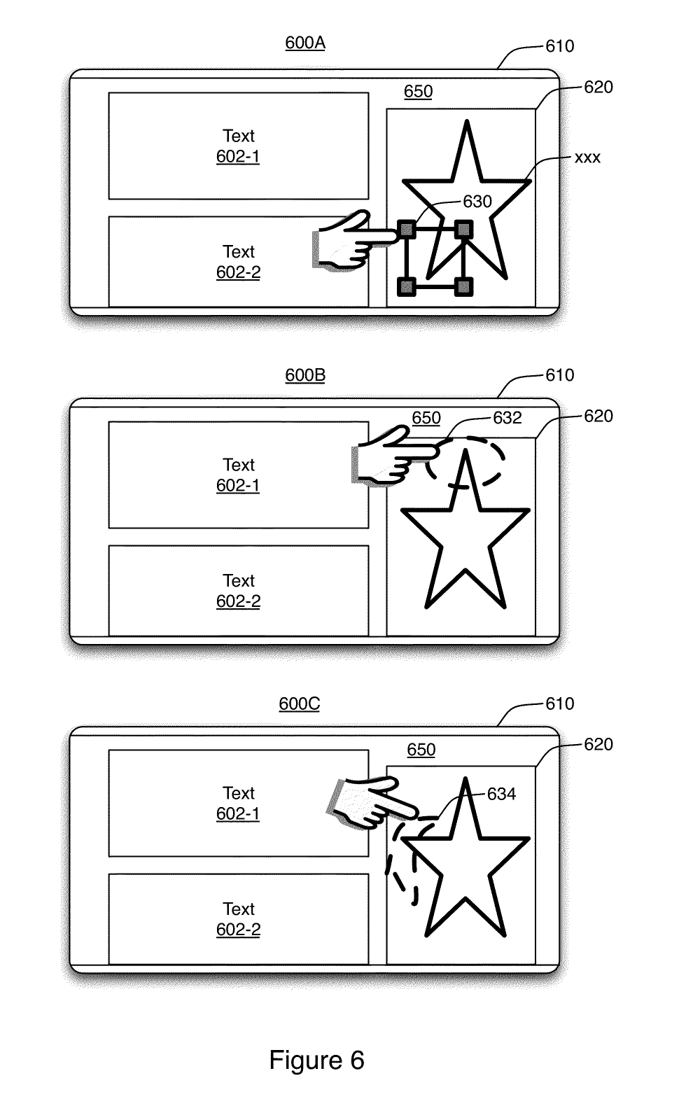

FIG. 6 illustrates an exemplary user interfaces for selecting a portion of displayed electronic content in accordance with some embodiments of the present invention. In some embodiments, FIG. 6 user interface 600A, includes the following elements, or a superset or a subset, thereof:
an application 610 (e.g., a web browser), capable of displaying a variety of electronic content 650, including text 602-1 and 602-2, and one or more images (e.g., 620); and
a selection area 630 enabling selection of portions of the displayed electronic content 620.

In some embodiments, the user is able to define a portion of an image as a selection area, or in other words, select a portion of an image. In these instances, for example, the selection area 630 may overlap with only a portion of an image, with the overlapping portion including the content to be selected. The features described above (e.g., search, copy, edit) with reference to FIG. 5 would then be applied to the portion of the selected image. By allowing a user to select a portion of an image or define the selection area to consist of a portion of an image, the user is able to perform all previously discussed features on just the selected portion of a given image. For example, the electronic content may include an image of a female model with a pair of red shoes. A user viewing the image may be interested in finding search results associated with just the red shoes, and thus may choose to place the selection area over the red shoes, with the red shoes within boundaries of the selection area. The user can then choose to submit a search query based on just the content within the boundaries of the selection (i.e., the red shoes). The search results returned by the search system 130 (FIG. 1) and the image search engine 134 (FIG. 1) may include women's shoes. In particular, the search results may contain results matching various criteria associated with the item being searched for. In this instance, the search results may include shoes matching the color of the shoes in the search query (i.e., red), shoes matching the brand of the shoes in the search query, shoes matching the general shape of the shoes submitted in the query.

As further illustrated in the exemplary user interface 600B and discussed above with reference to FIG. 5, the user may use any number of geometric shapes (e.g., polygons) to define the selection area. For example, user interface 600B illustrates an elliptical selection area, with user-adjustable size and positioning. In another example and as further illustrated in the exemplary user interface 600C, the user may also define the selection area as a freeform shape. The freeform shape, in some embodiments, is directly drawn onto a touchpad or touchscreen device by one or more of the user's finger. Alternatively, a stylus may be used to create and manipulate the freeform shape. Alternatively, or in addition to, the freeform shape can be formed by a mouse or other input device connected to client device 102.

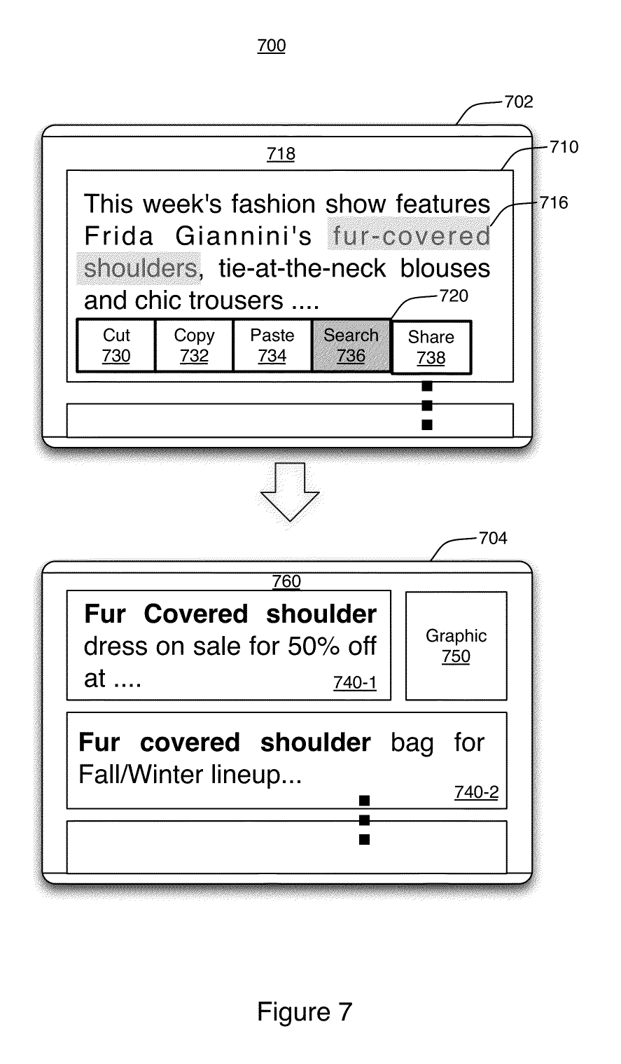

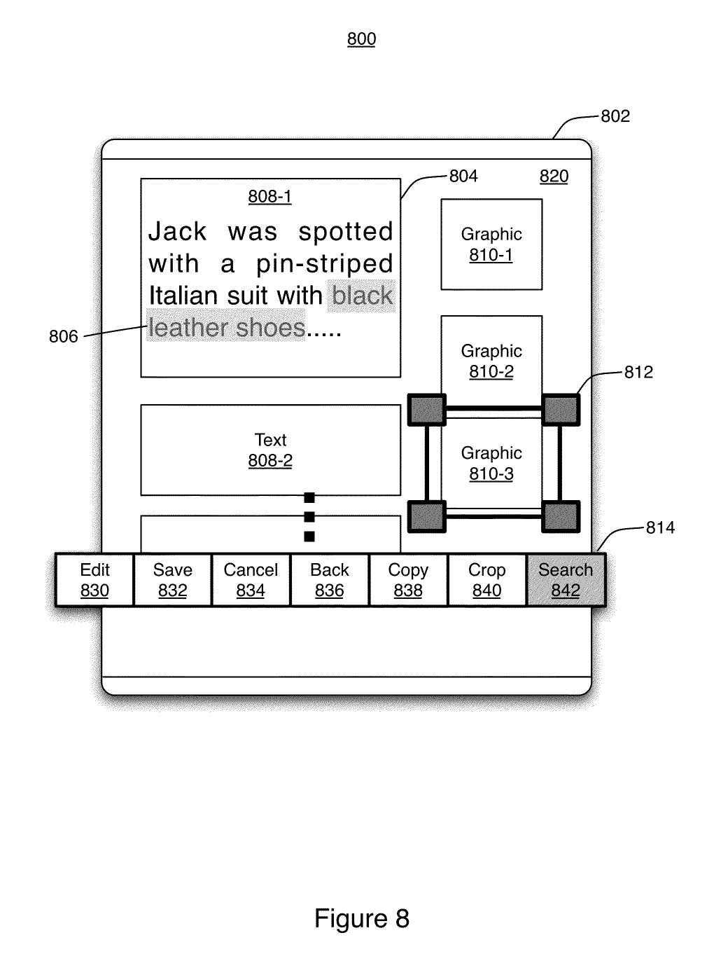

FIG. 7 and FIG. 8 illustrates exemplary user interfaces in accordance with some embodiments of the present invention.

In some embodiments, user interface 700, includes the following elements, or a superset or a subset, thereof:
an application 702 (e.g., a web browser), capable of displaying a variety of electronic content 718, including text 710 and one or more images;
a selection area 716 enabling selection of portions of the displayed electronic content 710;
one or more menu bars 720 containing options/features (e.g., Cut icon 730, copy icon 732, paste icon 734, search icon 736) for manipulating and processing selected information; and
an application 704 (e.g., web browser window), capable of display electronic content 760, including text 740 (e.g., 740-1 and 740-2) and one or more images (e.g., 750)

In some embodiments, a user may use the selection area 716 to select portions of electronic content displayed on the client device 102. In the instance shown in FIG. 7, the selection area overlaps with the words “fur-covered shoulders.” After selecting the phrase “fur-covered shoulders,” the user, in some embodiments, may immediate create and submit a search query based on the selected text (i.e., “fur-covered shoulders”). In some embodiments, submission of the search query to the search system is enabled through user activation of the search icon 736. Alternatively, the selected phrase may be save to the clipboard through, for example, the cut 730 and copy 732 icons. Furthermore, the selected phrase may be pasted into another application through, for example, the paste 734 icon.

In some embodiments, after receiving a search query based on the selected text, the search system returns a set of search results matching the search query (e.g., 740-1, 740-2, 750). The returned search results may include one or more images and text results relevant to the submitted search query.

FIG. 8 illustrates an exemplary user interface 800 in accordance with some embodiments of the present invention. In some embodiments, user interface 800, includes the following elements, or a superset or a subset, thereof:
an application 802 (e.g., a web browser), capable of displaying a variety of electronic content 820, including text (808-1, 808-2), and one or more images (810-1, 810-2, 810-3);
one or more selection areas (806, 812), enabling selection of portions of the displayed electronic content 820; and
one or more menu bars 814, containing options/features (e.g., Edit icon 830, Save icon 832, Cancel icon 834, Back icon 836, Cut icon 730, copy icon 732, paste icon 734, search icon 736).

In some embodiments, a plurality of selection areas may be displayed on client device 102, enabling the selection of multiple areas of the displayed electronic content 820. For example, the selection area may include a portion of the displayed text (i.e., “black leather shoes” 806), as well as, one or more images (i.e., Graphic 810-3). Content included in the selection area can then be manipulated and processed. For example, after defining the selection area, the user through activation of the displayed icons (e.g., 830, 832), edit, save, cancel, copy, crop, and search. These features are further discussed above in reference to FIG. 5. In some embodiments, the submitted search query is based on selected information containing one or more of the following: text, image, video and audio.

In some embodiments, the elements above or a superset or subset thereof are part of a standalone application on the client device 102. In some embodiments, the elements above or a superset or subset thereof are part of a client application 104 (e.g., a plug-in). In some embodiments, the elements above or a superset or subset thereof are in a combination of a standalone application and a part of a client application 104.

1. A computer-implemented method, the method comprising:
receiving electronic media content from a plurality of media sources, and displaying the electronic media content in accordance with pre-determined criteria;
providing a process for selecting one or more portions of the displayed electronic media content, wherein the process includes defining boundaries and position of a selection area, such that the displayed electronic media content overlapping the selection area is included in selected content; and
wherein information associated with the selected content is operable for creating a search request.

2. The computer-implemented method of claim 1 wherein the selected content is associated with one or more of the following types of information: a digital image, a portion of a digital image, video, audio, or at least one keyword.

3. The computer-implemented method of claim 1 wherein the search request is further based on information separate from the displayed electronic media content, the other information associated with one or more of: a second digital image, audio, and one or more keywords.

4. The computer-implemented method of claim 1 wherein the search request is further based on metadata associated with at least one of: a location of the mobile device, a location of a user of the mobile device, other viewers of the electronic media content.

5. The computer-implemented method of claim 1 wherein defining the boundaries of the selection area includes freeform selection of the displayed information.

6. The computer-implemented method of claim 1 wherein defining the boundaries of the selection area includes overlaying a geometric shape over the displayed electronic media content.

7. The computer-implemented method of claim 1 wherein the information associated with the selected content is operable for transmission to a storage device.

8. The computer-implemented method of claim 1 wherein the information associated with the selected content is operable for transmission to a third party.

9. A computer-readable storage medium containing one or more programs for providing instructions to one or more processors to perform the instructions, the instructions comprising:
receiving electronic media content from a plurality of media sources, and displaying the electronic media content in accordance with pre-determined criteria;
providing a process for selecting one or more portions of the displayed electronic media content, wherein the process includes defining boundaries and position of a selection area, such that the displayed electronic media content overlapping the selection area is included in selected content; and
wherein information associated with the selected content is operable for creating a search request.

10. The computer-readable storage medium of claim 9 wherein the selected content is associated with one or more of the following types of information: a digital image, a portion of a digital image, video, audio, or at least one keyword.

11. The computer-readable storage medium of claim 9 wherein the search request is further based on information separate from the displayed electronic media content, the other information associated with one or more of: a second digital image, audio, and one or more keywords.

12. The computer-readable storage medium of claim 9 wherein the search request is further based on metadata associated with at least one of: a location of the mobile device, a location of a user of the mobile device, other viewers of the electronic media content.

13. The computer-readable storage medium of claim 9 wherein defining the boundaries of the selection area includes freeform selection of the displayed information.

14. The computer-readable storage medium of claim 9 wherein the information associated with the selected content is operable for transmission to a storage device.

15. The computer-readable storage medium of claim 9 wherein the information associated with the selected content is operable for transmission to a third party.
